(19) United States
(12) Patent Application Publication
(10) Pub. No.: US 2004/0232709 A1
(43) Pub. Date: Nov. 25, 2004

(54) Remotely controlled cathode lock

(76) Inventors: Da-peng Zhang, Guangdong (CN); Martin Ralph Handford Cane, Lancashire (GB)

Correspondence Address: Hart Baxley Daniels & Holton, 90 John Street, Third Floor, New York, NY, 10038-3243, US

(21) Appl. No.: 10/483,341

(22) PCT Filed: Jul. 10, 2002
(86) PCT No.: PCT/CN02/00489

(30) Foreign Application Priority Data
Jul. 10, 2001 (CN) 01230319.4

(51) Int. Cl. E05C 19/00

(52) U.S. Cl. 292/302

(57) ABSTRACT

The present utility model is to provide a remotely controlled female lock, comprises a lock body, a latch and an electronic controller; said latch includes a latch body assembly, an unlock linkage mechanism and a relay, characterized in that, said lock further includes a remote controller, said remote controller comprises a radio transmitting-encoding circuit; said electronic controller comprises a radio receiving-decoding circuit, and said radio receiving-decoding circuit receives coded signals transmitted from said radio transmitting-encoding circuit, decodes the coded signals, and then transmits control signals to make the relay in the latch to electrically connected or disconnected. By implementing the remotely controlled lock of the present utility model, people can control the locking and unlocking at will by the remote controller within certain range, and the operation is very convenient. The lock of the present utility model is simple in structure, has a low production cost, and it is very practical for use.

### TECHNICAL FIELD

This utility model relates to lock technology, and more particular, to a kind of female lock which is locked and unlocked by controlling its latch.

### BACKGROUND OF THE UTILITY MODEL

Generally, a lock comprises a lock body and a latch. In order to satisfy the demands of people for a convenient and comfortable life, remotely controlled locks come into existence. Most of the existing remotely controlled locks are male locks, which are locked and unlocked by controlling the lock pin of the lock body. This kind of locks are complicated in structure and has a high production cost. Moreover, since the lock body is normally fixed on the object that needs to be repetitiously opened and closed, like a door, it is not good for the lining of the wires, and then control failures would easily happen. A remotely controlled female lock is normally used on the residence entrance doors, which includes a lock body, a latch and an electronic controller, wherein said latch includes a latch body assembly, an unlock linkage mechanism and relays. The existing remotely controlled female lock adopts the scheme of control-by-wire, wherein the electronic controller controls the connection and disconnection of the relay, drives the unlock linkage mechanism to actuate, and then makes the latch into the status of locking or unlocking. However, because the control-by-wire operation must be implemented at a fixed place, its usage is severely limited.

### SUMMARY OF THE UTILITY MODEL

The main object of the present utility model is to overcome the shortcomings of the prior art, and provide a remotely controlled female lock that is simple in structure, has low production cost and can be used conveniently.

The aim of the present utility model is achieved by the following scheme: a kind of remotely controlled female lock, comprises a lock body, a latch and an electronic controller; said latch includes a latch body assembly, an unlock linkage mechanism and a relay, wherein, said lock further includes a remote controller, said remote controller comprises a radio transmitting-encoding circuit; said electronic controller comprises a radio receiving-decoding circuit, and said radio receiving-decoding circuit receives coded signals transmitted from said radio transmitting-encoding circuit, decodes the coded signals, and then transmits control signals to make the relay in the latch to electrically connected or disconnected.

By implementing the remotely controlled lock of the present utility model, thanks to the usage of the wireless remote control technology, people can control the locking and unlocking at will by the remote controller within certain range, and the operation is very convenient. The lock of the present utility model is simple in structure, has a low production cost, and it is very practical for use.

### BRIEF DESCRIPTION OF THE DRAWINGS

FIG. 1 is an electronic circuit diagram of the radio transmitting-encoding circuit of the remote controller according to one embodiment of the present utility model;

FIG. 2 is an electronic circuit diagram of the radio receiving-decoding circuit of the electrical controller according to one embodiment of the present utility model;

FIG. 3 is a schematic view showing the structure of the latch according to one embodiment of the present utility model.

### DETAILED DESCRIPTION OF THE PREFERRED EMBODIMENTS

In one embodiment of the present utility model, said remotely controlled female lock includes a remote controller, an electronic controller, a lock body (not shown) and a latch.

In this embodiment, the radio control to the female lock is carried out by the leap encoding-decoding technology.

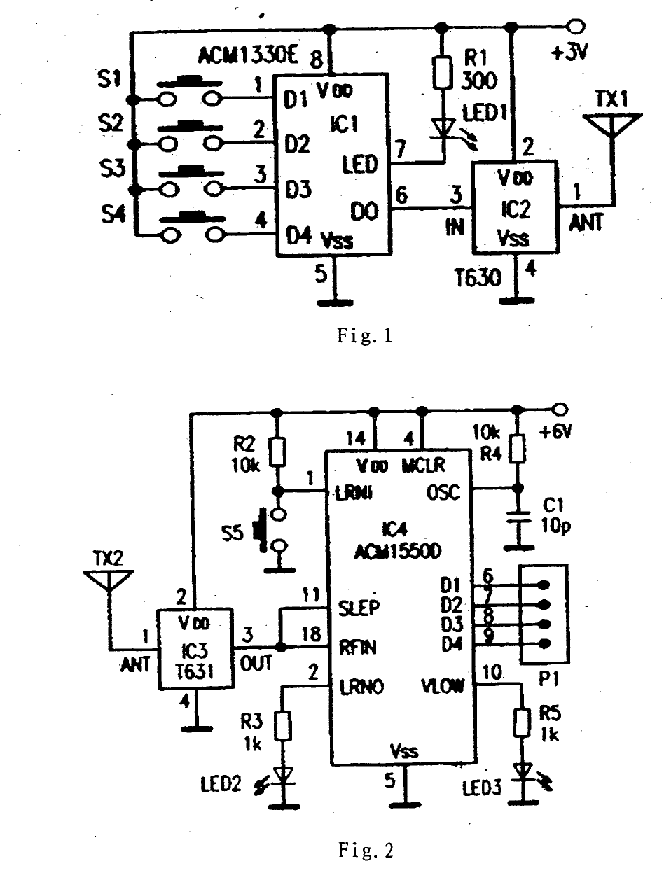

Said remote controller includes keystrokes, radio transmitting-encoding circuit and a battery. The whole remote controller can be made very compact like a key buckle, so as to be portable and easy for hand hold. As shown in FIG. 1, the radio transmitting-encoding circuit is mainly comprised of a leap encoder (IC1) and a radio frequency (RF) serial data module (IC2). Said leap encoder can use the chip ACM1330E, wherein D1 to D4 is the password input terminals for locking (or unlocking), the password can be set to 1 to 4 bits, DO is the output terminal.

Said electric controller includes a radio receiving-decoding circuit and an electric switch. The whole electric controller can be made on a single circuit board, which is installed at the rear side of the latch housing. As shown in FIG. 2, the radio receiving-decoding circuit is comprised of a RF serial data demodule (IC3) and a leap encoder (IC4). Said leap encoder can use the chip ACM1550D, wherein D1-D4 are the output terminals, the internal circuit at the OSC terminal constructs a cheap RC timing oscillator with the external resistance R4 and capacitance C1, LRN1 and LRN0 are the I/O (input and output) terminals for study function.

The process of the radio transmitting and receiving is as follows: press S1-S4 to input the password for locking or unlocking, at the meantime, a random code will be automatically created in the ACM1330E chip, the code generated will be used to make calculation with the input locking or unlocking password and a new password is created, which is then output via the output terminals of the chip ACM1330E and sent out after modulated by the chip IC2. The signals sent from the remote controller is demodulated by the chip IC3 of the radio receiving-decoding circuit, and then is input into the chip ACM1550D for password identification, and is output to the electric switch via the output terminals after calculation and encoding, so as to make the relay in the latch to electrically connected or disconnected.

Before the first use, the radio receiving-decoding circuit of the electrical controller needs to carry out at least once study via the I/O terminals, so as to make the serial passwords of the leap-encoder and leap-decoder synchronized.

The leap-encoder and the leap-decoder chips used in this embodiment can automatically create passwords of up to 66 bits, therefore, the amount of non-repeated combinations can be up to 2⁶⁶, which will take more than 100 billion years to scan for a scanner. With the password arithmetic used in the present radio transmitting and receiving circuit, a twice response will never happen to the same password, and various kinds of decoding to the passwords such as scanning, grabbing, etc. can be prevented. Moreover, the leap-decoder chip used in this embodiment has the ability of study, whereby each decoder can receive encoding signals from 4 to 6 different encoders simultaneously.

In this embodiment, the signal carrier for radio transmitting and receiving is of RF 315 MHz (for China) or 433 MHz (for Europe). The transmitting power is at milli-watt level, and the transmitting distance is up to 100 meters, thereby, it will not interfered with other electrical apparatus, and it is very convenient for the users.

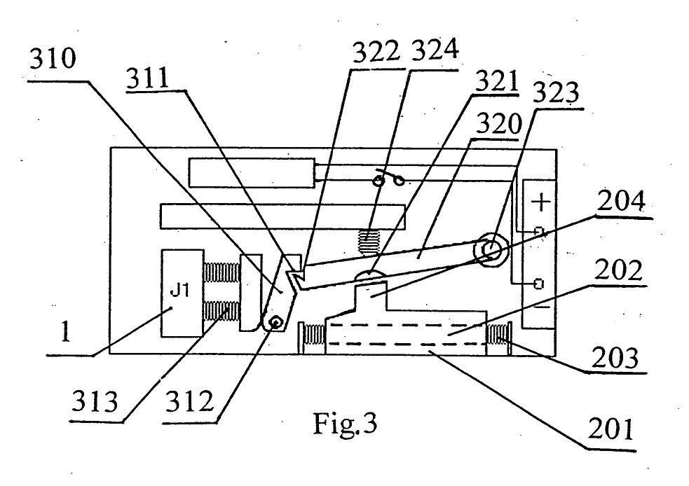

As shown in FIG. 3, the latch includes a latch body assembly, an unlock linkage mechanism and a relay; they are all installed in the latch housing (not shown).

The latch body assembly includes a latch body 201, a latch rotor 202, a resilient restoring mechanism 203 and a stop mechanism 204. The latch rotor 202 is fixed in the latch housing and is vertical to the lock pin of the lock body. The latch body 201 is in the shape of a slot with an inclined surface and can be rotated around said latch rotor 202. On the latch rotor 202 are installed resilient restoring mechanisms 203 which are located against the two ends of the latch body 201. Said resilient restoring mechanisms 203 may be in the form of clip springs. Said stop mechanism 204 is located at the rear side (the direction facing the lock pin is defined as front) of the latch body 201, and it is a protruding inclined member integrally formed with said latch body 201.

The unlock linkage mechanism includes an unlock trigger 310 and an unlock control lever 320. Said unlock control lever 320 is located behind the latch body assembly, at the front side of which is provided an inclined slot matching with said stop mechanism 204 of said latch body 201. A hook shaped mechanism 322 is installed at the free end of said unlock control lever 320 which is hinged to said latch housing with an axle 323. At its rear side, said unlock control lever 320 is connected to said latch housing by a resilient restoring mechanism 324, which generates a resilient restoring force away from the latch body assembly. Said unlock trigger 310 is installed beside the latch body 201 and the flee end of the unlock control lever 320, on the unlock trigger 310 is installed a slot 311 matching with the hook shaped mechanism 322 on the top of the unlock control lever 320. The other end of said unlock trigger 310 is hinged to the latch housing with an axle 312. The unlock trigger 310 is connected to the latch housing via a resilient restoring mechanism 313 which generates a resilient restoring force facing the unlock control lever 320. In this embodiment, the resilient restoring mechanisms for both the unlock trigger 310 and the unlock control lever 320 are in the form of springs.

The relay 1 is installed beside the unlock trigger 310, opposite to the unlock control lever 320.

The lock body of this utility model can be in the form of prior art. Therefore, there is no need to change the existing lock body when implementing this utility model, which is convenient for modifying and replacing the existing locks. At abnormal situations such as electricity shutdown or lost of the remote controller when the lock latch can not be controlled, the users may still unlock by operating the lock pin in the lock body with the key, without causing much inconvenience.

When unlocking, aim the lock pin of the lock body at the latch body 201 of the latch, make the lock pin extending into and fixed in the slot structure of the latch body 201; at this time, the relay 1 is electrically disconnected, due to the effect of the resilient restoring mechanism 313, the unlock trigger 310 rotates toward the unlock control lever 320, and is fastened with said unlock control lever 320 by the engagement of the slot 311 with the hook shaped mechanism 322. Further, the unlock control lever 320 is driven forward and engaged with the stop mechanism 204, so as to make the latch body 201 fixed at the locking position. When unlocking, the relay 1 is electrically connected and produces attraction force to make the unlock trigger 310 away from the unlock control lever 320. The unlock control lever 320 is released, and then moves away from the latch body 201 under the effect of the resilient restoring mechanism 324, so that, the stop mechanism 204 of the latch is released. By pushing the door, the lock pin drives the latch body 201 to rotate to the unlocking position around the rotor 202, and slips out along the slant of the slot structure, so as to realize the unlocking function. After the lock pin completely slips out, because of the restoring function of the clip springs 203, the latch body 201 returns to the locking position automatically.

What is claimed is:

1. A remotely controlled female lock, comprises a lock body, a latch and an electronic controller; said latch includes a latch body assembly, an unlock linkage mechanism and a relay, characterized in that, said lock further includes a remote controller, said remote controller comprises a radio transmitting-encoding circuit; said electronic controller comprises a radio receiving-decoding circuit, and said radio receiving-decoding circuit receives coded signals transmitted from said radio transmitting-encoding circuit, decodes the coded signals, and then transmits control signals to make the relay in the latch to electrically connected or disconnected.

2. A remotely controlled female lock according to claim 1, characterized in that, said radio transmitting-encoding circuit comprises a leap encoder (IC1) and a radio frequency (RF) serial data module (IC2); said radio receiving-decoding circuit comprises a RF serial data demodule (IC3) and a leap decoder (IC4).

3. A remotely controlled female lock according to claim 2, characterized in that, said leap encoder can use the chip ACM1330E.

4. A remotely controlled female lock according to claim 2, characterized in that, said leap decoder can use the chip ACM1550D.

5. A remotely controlled female lock according to claim 1, characterized in that, said radio transmitting-encoding circuit and said radio receiving-decoding circuit use the 315 MHz radio frequency wave as the signal transmission carrier.

6. A remotely controlled female lock according to claim 1, characterized in that, said radio transmitting-encoding circuit and said radio receiving-decoding circuit use the 433 MHz radio frequency wave as the signal transmission carrier.

7. A remotely controlled female lock according to claim 1 or 2, characterized in that, said latch body assembly, unlock linkage mechanism and relay are all installed in the latch housing; said latch body assembly includes a latch body, a latch rotor, resilient restoring mechanisms and a stop mechanism; said latch rotor is fixed in the latch housing and is vertical to the lock pin of said lock body, said latch body is in the shape of a slot with an inclined surface and can be rotated around said latch rotor; on the latch rotor are installed resilient restoring mechanisms; said stop mechanism is located at the rear side of the latch body, and it is a protruding inclined member integrally formed with said latch body.

8. A remotely controlled female lock according to claim 7, characterized in that, said unlock linkage mechanism includes an unlock trigger and an unlock control lever; said unlock control lever is located behind the latch body assembly, at the front side of the unlock control lever is provided an inclined slot matching with said stop mechanism of said latch body; a hook shaped mechanism is installed at the free end of said unlock control lever which is hinged to said latch housing with an axle; at its rear side, said unlock control lever is connected to said latch housing by a resilient restoring mechanism, which generates a resilient restoring force away from the latch body assembly; said unlock trigger is installed beside the latch body and the free end of the unlock control lever, on the unlock trigger is installed a slot matching with the hook shaped mechanism on the top of the unlock control lever; the other end of said unlock trigger is hinged to the latch housing with an axle; the unlock trigger is connected to the latch housing via a resilient restoring mechanism, which generates a resilient restoring force towards the unlock control lever; said relay is installed beside the unlock trigger, opposite to the unlock control lever.
